(19) United States
(12) Patent Application Publication
(10) Pub. No.: US 2008/0183486 A1
(43) Pub. Date: Jul. 31, 2008

(54) COMPUTER METHOD OF COLLECTING, MANAGING AND USING JOB APPLICANT DATA FOR SPECIFIC EMPLOYMENT OPPORTUNITIES

(76) Inventors: Leora B. Baumgarten, Chicago, IL (US); Charles I. Smith, Chicago, IL (US); Ramalakshmi Ramadas, Chicago, IL (US)

Correspondence Address: HOLLAND & KNIGHT LLP, 10 ST. JAMES AVENUE, 11th Floor, BOSTON, MA, 02116-3889, US

(21) Appl. No.: 12/032,531

(22) Filed: Feb. 15, 2008

Related U.S. Application Data
(63) Continuation-in-part of application No. 11/953,460, filed on Dec. 10, 2007.
Application No. 11/953,460 is a continuation of application No. 11/336,574, filed on Jan. 20, 2006, now abandoned.
(60) Provisional application No. 60/645,977, filed on Jan. 21, 2005.
(60) Provisional application No. 60/721,654, filed on Sep. 29, 2005.

(51) Int. Cl. G06Q 10/00

(52) U.S. Cl. 705/1

(57) ABSTRACT

A method and computer program product include providing a generic employment application. A customized employment application is generated by an employer based upon, at least in part, the generic employment application. A unique web page is associated with the customized employment application. Access by a prospective employee is provided to the unique web page associated with the customized employment application.

### RELATED APPLICATIONS

This application is a continuation-in-part of U.S. patent application Ser. No. 11/953,460, filed Dec. 10, 2007, which claims priority to U.S. patent application Ser. No. 11/336,574, filed Jan. 20, 2006, which claims priority to U.S. Provisional Application Ser. Nos. 60/645,977, filed Jan. 21, 2005 and 60/721,654, filed Sep. 29, 2005, the entire disclosures of which are herein incorporated by reference.

### FIELD OF THE DISCLOSURE

The present disclosure relates to preparing and managing employment applications and the prospective employee information submitted in association with such applications, and more specifically to preparing and managing the employment applications and information for specific employment opportunities.

### BACKGROUND

It is a well established practice that many employers, whether they are a corporation, organization or other entity seeking to identify individuals who might potentially be employed, may announce specific employment opportunities in the newspaper, on job board web sites, and the like. These newspapers and web sites may be partially or wholly dedicated to employment announcements. These employers may also announce employment opportunities on their own web site as well as other media such as radio or TV. As a result of an announcement or help wanted classified ad, many potential employees, or job candidates, may send information to the employer to indicate the candidates' interest in, and qualifications for, the announced opportunity. Candidates may submit this information to the employer utilizing the method or methods requested by the employer in the advertisement. It is common for employers to request a resume and cover letter to be sent by a number of methods, including postal service, email service and facsimile service.

Employers commonly receive many resumes in response to each advertised announcement. Organizing, evaluating and storing the responses can represent a formidable problem, especially if the responses arrive in a variety of formats. Employers must be able to identify duplicate submissions, evaluate submissions for appropriate qualifications and manage a pre-employment process whose goal is to identify the best qualified candidate for the open position and extend an offer for employment to that individual. Additionally, employers are required by law to meet certain minimum standards for storage of candidate information following advertisements of employment opportunities.

There are various known systems for recruiting employees. For example, there are many well known job boards which advertise job openings. Some of these allow the job seekers to search for jobs and submit an application including a resume, online. Some of these systems allow the employer to select from a set of pre-screening questions that may be automatically scored. Candidates whose answers do not match the pre-set criteria are automatically rejected from the applicant pool. However, employers typically cannot search the entire applicant pool based on the answers the candidate provided to pre-screening questions. Further, some systems may require job seekers to pre-register and obtain a username and password prior to submitting their application, adding a cumbersome and often confusing intervening step for the job seeker. Additionally, delivery of candidate information to the employer is often accomplished using email. This causes an increased email volume burden for the employer. Another drawback is that employers may not have the option of setting up a customized or “branded” web portal for their applicants.

### SUMMARY

The present disclosure provides a method of managing employment applications and information and a computer program product for implementing the method.

In general, in one implementation a method includes providing a generic employment application. A customized employment application is generated by an employer based upon, at least in part, the generic employment application. A unique web page may be associated with the customized employment application. Access by a prospective employee is provided to the unique web page associated with the customized employment application.

One or more of the following features may be included. The customized employment application may include a job description. The customized employment application may also include one or more questions related to at least one of an education history, an employment history, experience in one or more employment related areas, one or more skills, one or more personal references and one or more referrals. A resume submission option may also be included in the customized employment application. The customized employment application may include one or more custom questions generated by an employer.

A unique job identification number may be assigned to the customized employment application. The unique web page including the customized employment application may be associated with the unique job identification number. The unique web page may be accessible to unregistered prospective employees.

User input may be received including prospective employee responses to one or more questions included within the customized employment application. The user input may be stored in a data store.

Customized searches of the user input stored in the data store may be conducted by the employer. Comments related to the user input may be generated and appended by the employer. Access to the user input stored in the data store may be restricted to the employer who generated the customized employment application. A plurality of access levels to the user input stored in the data store may be provided.

In another implementation, a computer program product resides on a computer readable medium having a plurality of instructions stored on it. When executed by a processor, the instructions cause the processor to perform operations including providing a generic employment application. A customized employment application is generated by an employer based upon, at least in part, the generic employment application. A unique web page is associated with the customized employment application. Access is provided to the unique web page associated with the customized employment application by prospective employees.

One or more of the following features may be included. The customized employment application may include a job description. The customized employment application may also include one or more questions related to at least one of an education history, an employment history, experience in one or more employment related areas, one or more skills, one or more personal references and one or more referrals. A resume submission option may also be included in the customized employment application. The customized employment application may include one or more custom questions generated by an employer.

Instructions may be included for assigning a unique job identification number to the customized employment application. Instructions may also be included for associating the unique web page including the customized employment application with the unique job identification number. The unique web page may be accessible to unregistered prospective employees.

Instructions may be included for receiving user input including prospective employee responses to one or more questions included within the customized employment application. The user input may be stored in a data store.

Instructions may be included for conducting customized searches of the user input stored in the data store by the employer. Instructions may also be included for generating and appending comments related to the user input by the employer. The computer program product may also include instructions for restricting access to the user input stored in the data store to the employer who generated the customized employment application. A plurality of access levels to the user input stored in the data store may be provided.

The details of one or more implementations are set forth in the accompanying drawings and the description below. Other features and advantages will become apparent from the description, the drawings and the claims.

### BRIEF DESCRIPTION OF THE DRAWINGS

FIG. 1 is a diagrammatic view of an employment application and information management process coupled to a distributed computing network.

FIG. 2 is a diagrammatic view of a display screen rendered by the employment application and information management process of FIG. 1.

FIG. 3 is a flow chart of a process executed by the employment application and information management process of FIG. 1.

FIG. 4 is a diagrammatic view of a display screen rendered by the employment application and information management process of FIG. 1.

FIG. 5 is a diagrammatic view of a display screen rendered by the employment application and information management process of FIG. 1.

FIG. 6 is a diagrammatic view of a display screen rendered by the employment application and information management process of FIG. 1.

FIG. 7 is a diagrammatic view of a display screen rendered by the employment application and information management process of FIG. 1.

FIG. 8 is a diagrammatic view of a display screen rendered by the employment application and information management process of FIG. 1.

FIG. 9 is a diagrammatic view of a display screen rendered by the employment application and information management process of FIG. 1.

FIG. 10 is a diagrammatic view of a display screen rendered by the employment application and information management process of FIG. 1.

FIG. 11 is a diagrammatic view of a display screen rendered by the employment application and information management process of FIG. 1.

FIG. 12 is a diagrammatic view of a display screen rendered by the employment application and information management process of FIG. 1.

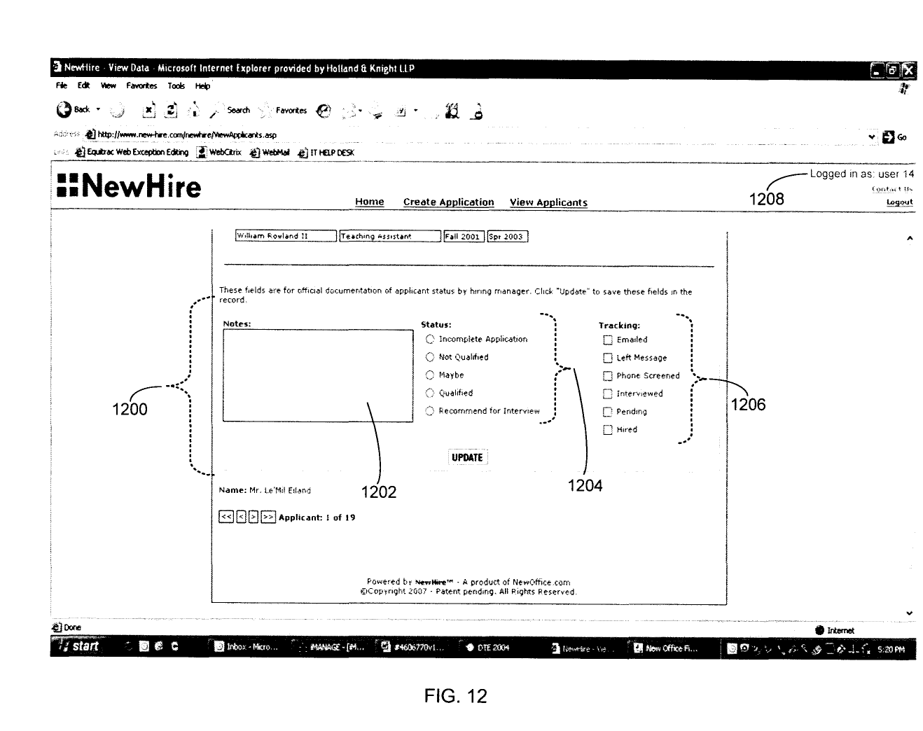

Like reference symbols in the various drawings indicate like elements.

### DETAILED DESCRIPTION OF THE PREFERRED EMBODIMENTS

### System Overview:

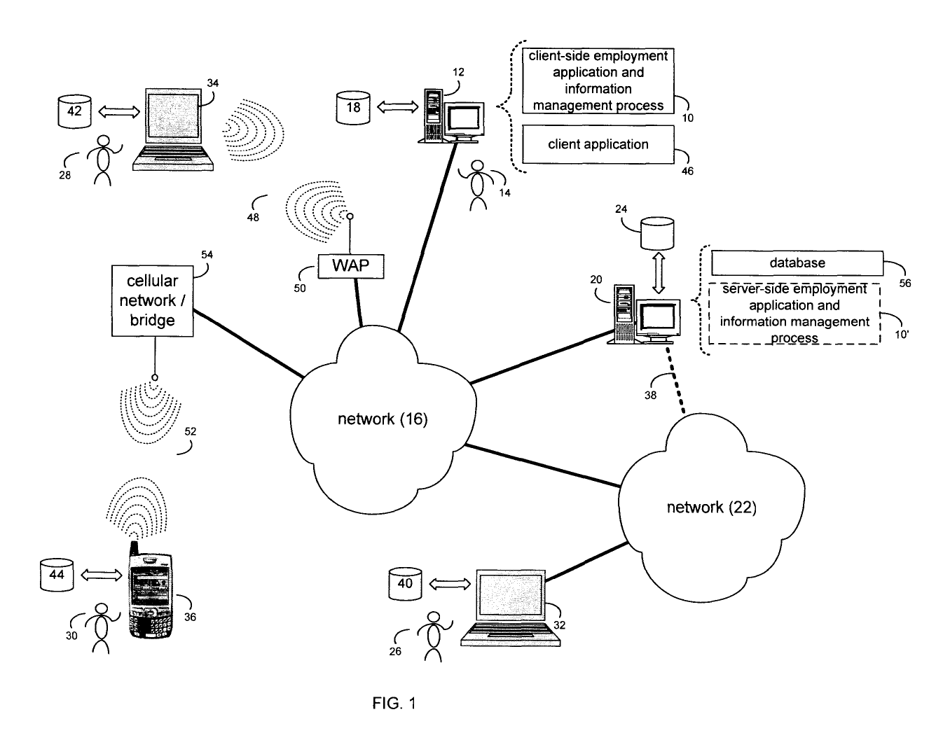

Referring to FIG. 1, there is shown employment application and information management process 10 that may reside on and may be executed by a computing device (e.g., client computer 12). Examples of computing devices may include, but are not limited to, personal computers, laptop computers, notebook computers, and personal digital assistants, for example. As will be discussed below in greater detail, employment application and information management process 10 may allow an employer or user 14 to create and modify a customized employment application, enabling additional users to access and input information into the customized employment application, and enabling the employer to search and manage the input information.

Employment application and information management process 10 may be a client-side application that resides on and is executed by e.g., client computer 12, which may be connected to network 16 (e.g., the Internet). The instruction sets and subroutines of employment application and information management process 10, which may be stored on a storage device 18 coupled to client computer 12, may be executed by one or more processors (not shown) and one or more memory architectures (not shown) incorporated into client computer 12. Storage device 18 may include but is not limited to: a hard disk drive; a tape drive; an optical drive; a RAID array; a random access memory (RAM); a read-only memory (ROM); a compact flash (CF) storage device, a secure digital (SD) storage device, and a memory stick storage device.

Additionally/alternatively, the above-described employment application and information management process may be a server-side application, as represented in FIG. 1 by server-side employment application and information management process 10′ (shown in phantom). Server-side employment application and information management process 10′ may reside on and be executed by server computer 20, which may be coupled to network 16. Examples of server computer 20 may include, but are not limited to: a personal computer, a server computer, a series of server computers, a mini computer, and a mainframe computer, for example. Server computer 20 may execute a network operating system, examples of which may include but are not limited to: Microsoft Windows XP Server™; Novell Netware™; or Redhat Linux™, for example.

Server computer 20 may execute a web server application, examples of which may include but are not limited to: Microsoft IIS™, Novell Webserver™, or Apache Webserver™, that allows for HTTP (i.e., HyperText Transfer Protocol) access to server computer 20 via network 16. Network 16 may be coupled to one or more secondary networks (e.g., network 22), examples of which may include but are not limited to: a local area network; a wide area network; or an intranet, for example.

The instruction sets and subroutines of server-side employment application and information management process 10′, which may be stored on a storage device 24 coupled to server computer 20, may be executed by one or more processors (not shown) and one or more memory architectures (not shown) incorporated into server computer 20. Storage device 24 may include but is not limited to: a hard disk drive; a tape drive; an optical drive; a RAID array; a random access memory (RAM); a read-only memory (ROM); a compact flash (CF) storage device, a secure digital (SD) storage device, and a memory stick storage device.

As discussed above, the employment application and information management process may be a client-side application (e.g., client-side employment application and information management process 10), a server-side application (e.g., server-side employment application and information management process 10′), or a hybrid client-side/server-side application (e.g., using portions of both client-side employment application and information management process 10 and server-side employment application and information management process 10′). Accordingly, the manner in which the employment application and information management process is accessed may vary depending on whether the employment application and information management process is a client-side application, a server-side application, or a hybrid client-side/server-side application.

If a client-side application, users 14, 26, 28, 30 may access the client-side employment application and information management process (e.g., client-side employment application and information management process 10) directly through the device on which the client-side employment application and information management process is executed, namely client computer 12, notebook computer 32, laptop computer 34 and personal digital assistant 36, for example. For clarity, only client-side employment application and information management process 10 residing on client computer 12 is shown. Client-side employment application and information management process 10 may reside on and be executed by other computing devices (e.g., notebook computer 32, laptop computer 34 and personal digital assistant 36) in a corresponding manner. The instruction sets and subroutines of client-side employment application and information management process 10, which may be stored on a storage device (e.g., storage device 18, 40, 42, 44) coupled to the computing device (e.g., client computer 12, notebook computer 32, laptop computer 34 and personal digital assistant 36, respectively). Client-side employment application and information management process 10, may be executed by one or more processors (not shown) and one or more memory architectures (not shown) incorporated into the computing device executing client-side employment application and information management process 10. Storage devices 18, 40, 42, 44 may include but are not limited to: a hard disk drive; a tape drive; an optical drive; a RAID array; a random access memory (RAM); a read-only memory (ROM); a compact flash (CF) storage device, a secure digital (SD) storage device, and a memory stick storage device.

Alternatively, if a server-side application, users 14, 26, 28, 30 may access the server-side employment application and information management process (e.g., server-side employment application and information management process 10′) through network 16 or through secondary network 22. Server computer 20 (i.e., the computer that executes server-side employment application and information management process 10′) may be coupled to network 16 through secondary network 22, as illustrated with phantom link line 38.

If accessing server-side employment application and information management process 10′, client computer 12, notebook computer 32, laptop computer 34 and personal digital assistant 36 may each execute a client application (e.g., client application 46) that may interface with server-side employment application and information management process 10′ and facilitate the bidirectional transfer of data between e.g., client computer 12 and server computer 20.

The client application (e.g., client application 46) may be a web browser (e.g., Microsoft Internet Explorer™ and Netscape Navigator™, for example), a stand alone application, or an applet running within another program (e.g., Microsoft Internet Explorer™ and Netscape Navigator™, for example).

Client computer 12, notebook computer 32, laptop computer 34 and personal digital assistant 36 may each execute an operating system, examples of which may include but are not limited to Microsoft Windows™, Microsoft Windows Mobile™, Redhat Linux™, or a custom operating system.

The various computing devices (e.g., client computer 12, notebook computer 32, laptop computer 34 and personal digital assistant 36) may be directly or indirectly coupled to network 16 (or network 22). For example, client computer 12 is shown directly coupled to network 16 via a hardwired network connection, and notebook computer 32 is shown directly coupled to network 22 via a hardwired network connection.

Laptop computer 34 is shown wirelessly coupled to network 16 via wireless communication channel 48 established between laptop computer 34 and wireless access point (i.e., WAP) 50, which is shown directly coupled to network 16. WAP 50 may be, for example, an IEEE 802.11a, 802.11b, 802.11g, Wi-Fi, and/or Bluetooth device that is capable of establishing wireless communication channel 48 between laptop computer 34 and WAP 50.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Personal digital assistant 36 is shown wirelessly coupled to network 16 via wireless communication channel 52 established between personal digital assistant 36 and cellular network/bridge 54, which is shown directly coupled to network 16.

### The Employment Application and Information Management Process:

As discussed above, the employment application and information management process 10, 10′ may be a client-side application, a server-side application, or a hybrid client-side/server-side application. Accordingly, the following disclosure is applicable to all variants of the employment application and information management process.

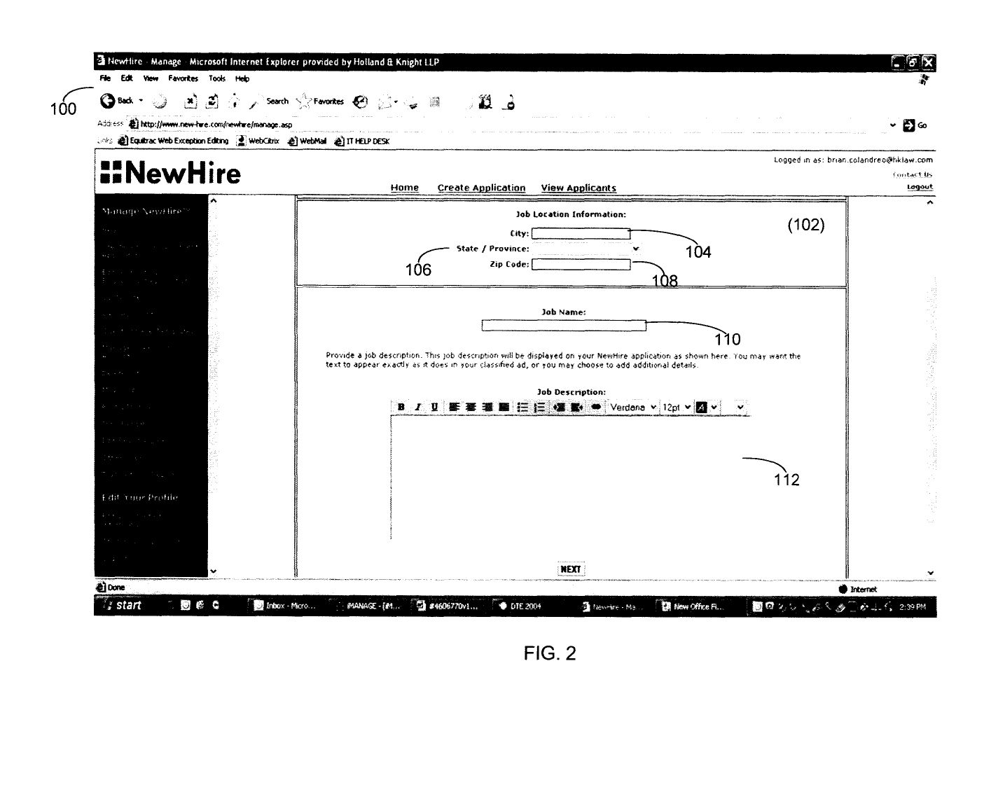

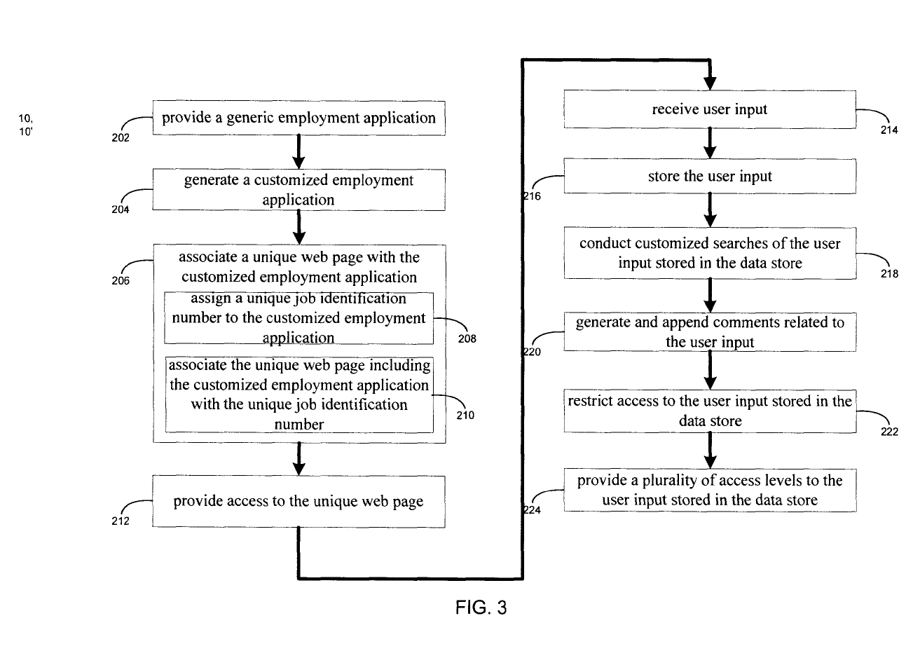

Referring also to FIGS. 2 through 5, employment application and information management process 10, 10′ and/or application 46 may render user interface screen 100, which allows an employer (e.g., user 14) to perform various tasks associated with creating, maintaining and completing an employment application. For example, via user interface screen 100, employment application and information management process 10, 10′ may provide 202 a generic employment application 102, and may allow user 14 to generate 204 a customized employment application from a generic employment application 102. The generic employment application 102 may include selection menus and input options that may be used by user 14 to generate 204 the customized employment application. The selection menus and input options may include one or more fields allowing user 14 to generate 204 the customized application. The one or more fields may include, but are not limited to, for example, job location information, such as the city field 104, state or province field 106, and zip code field 108 for the job or position being advertised. Generic employment application 102 may also include job name field 110 for the title or name of the job and job description field 112, allowing user 14 to provide a description of the position being advertised. In job description field 112 user 14 may input, for example, a description of the duties associated with the advertised job, salary and benefits information, experience required and any additional information the employer may choose to provide in describing the advertised job.

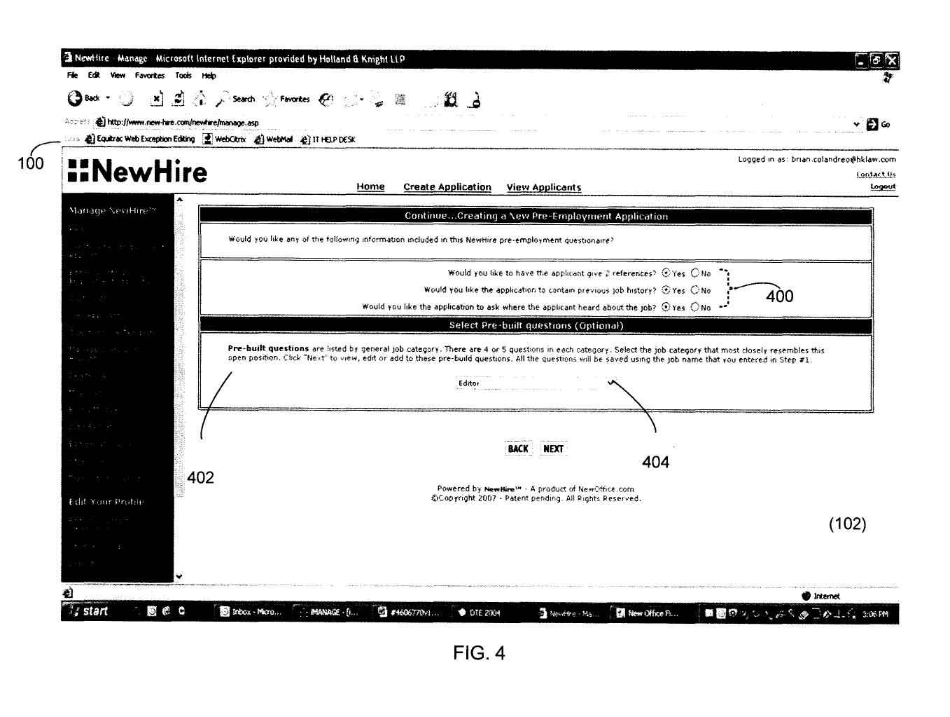

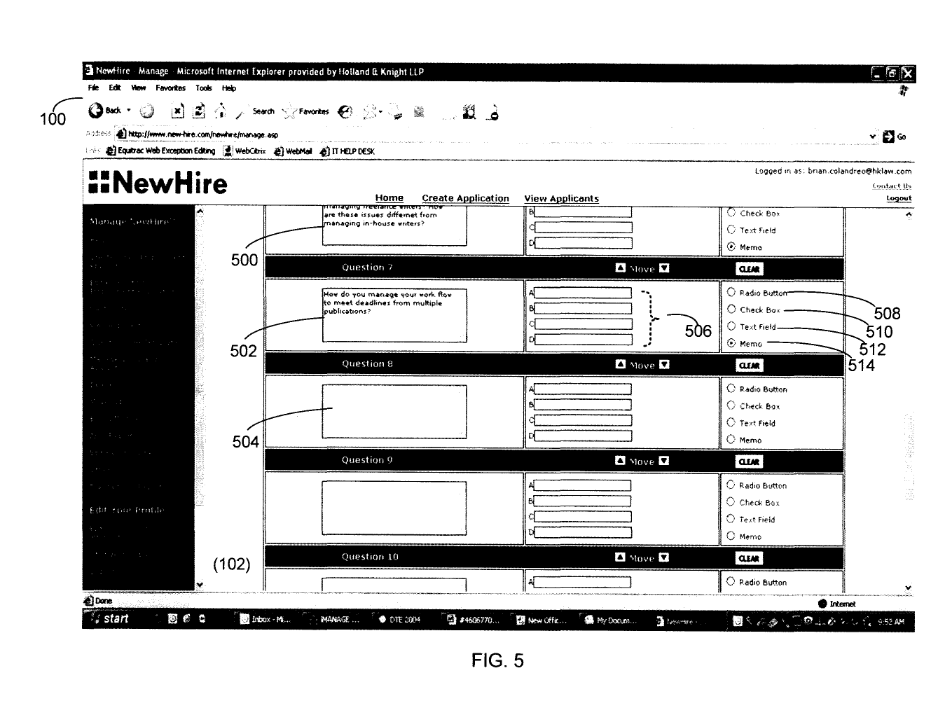

Referring also to FIG. 4, and continuing with the above-stated example, generic employment application 102 may also include options 400 for selecting generic pre-built questions, such as a request for references, a request for employment history, applicant contact information, applicant start date, a resume submission option and where the applicant heard about the job. Generic application 102 may also include an option 402 for adding templates for job-specific pre-built questions by selecting the specific job to be advertised from drop down menu 404, a list, or similar arrangement. Generic application 102 may include a library of job-specific templates including the job-specific pre-built questions 402 that the employer may include. For example, as shown in FIG. 4, user 14 may select the job “Editor” from drop down menu 404. Continuing with the above-stated example, and referring also to FIG. 5, selecting the job “Editor” may result in employment application and information management process 10, 10′ adding one or more templates for job-specific pre-built questions 500, 502 related to the position of “Editor” to the customized employment application being generated 204.

Still referring to FIG. 5, generic employment application 102 may include input fields 504 allowing user 14 (i.e., the employer) to add custom questions generated by user 14 to the employment application. Each of job-specific pre-built questions 500, 502 from the job-specific template and custom questions input fields 504 may include one or more answer input fields (e.g., answer input field 506 associated with pre-built question 502). Answer input field 506 may allow user 14 to provide one or more possible answers that an applicant may select. Employment application and information management process 10, 10′ may allow user 14 to select the manner in which an applicant may answer a pre-built or custom question. For example, employment application and information management process 10, 10′ may allow an employer, e.g., user 14, to select for the answer choices (e.g., answer input field 506) to be presented in radio button form 508, check box form 510, text field form 512, or memo form 514, depending upon the type of question and the type of response required. In instances where radio button form 508 and/or check box form 510 is selected by user 14 as an answer choice, the user 14 may provide possible answers to the specific questions.

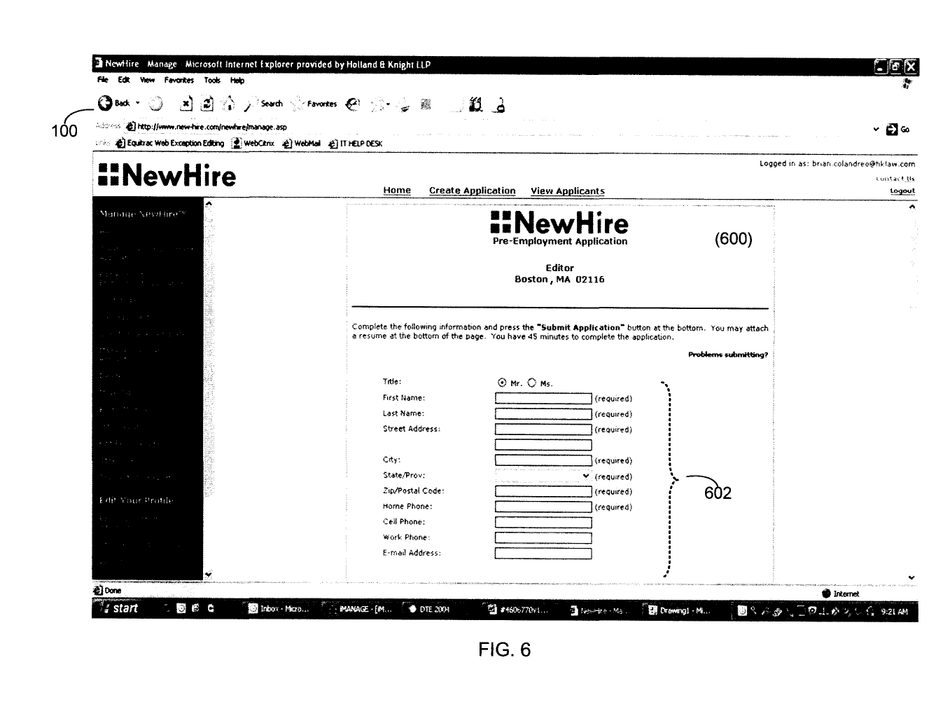

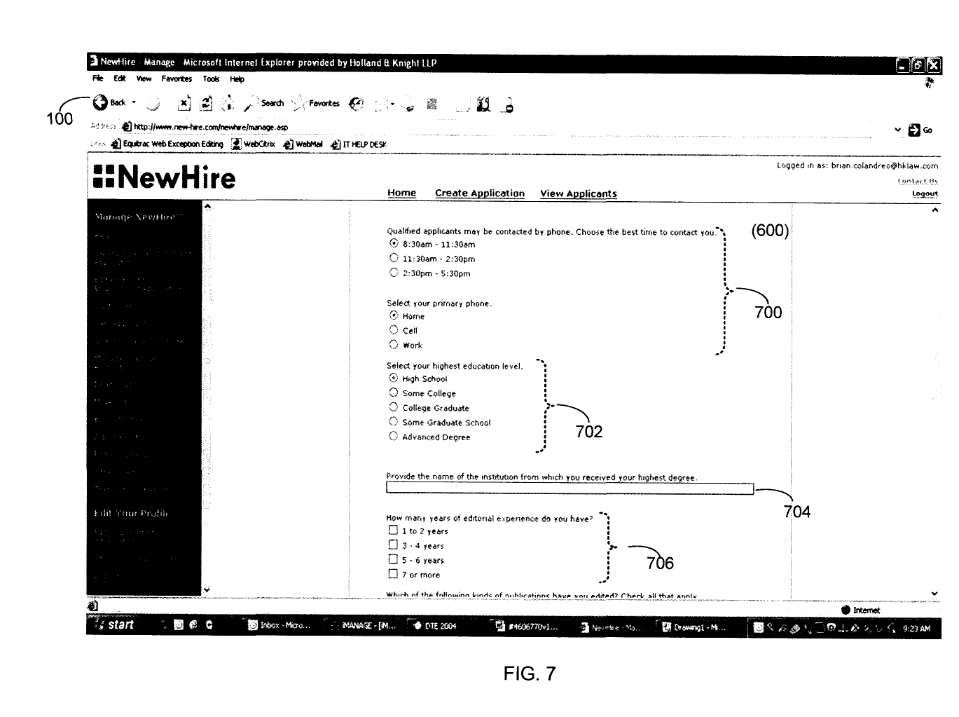

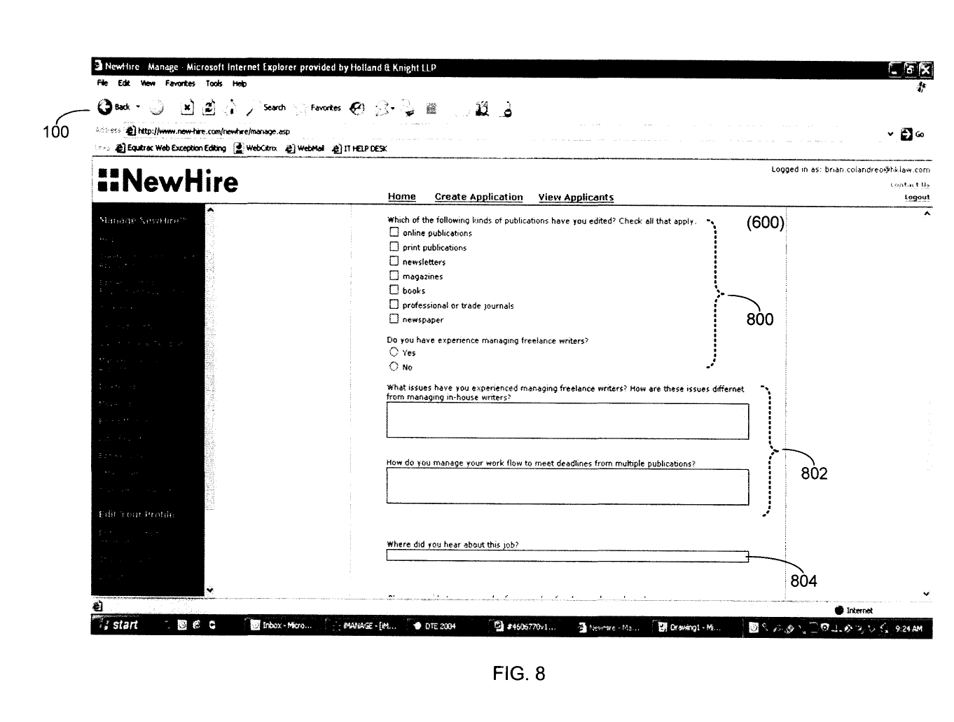

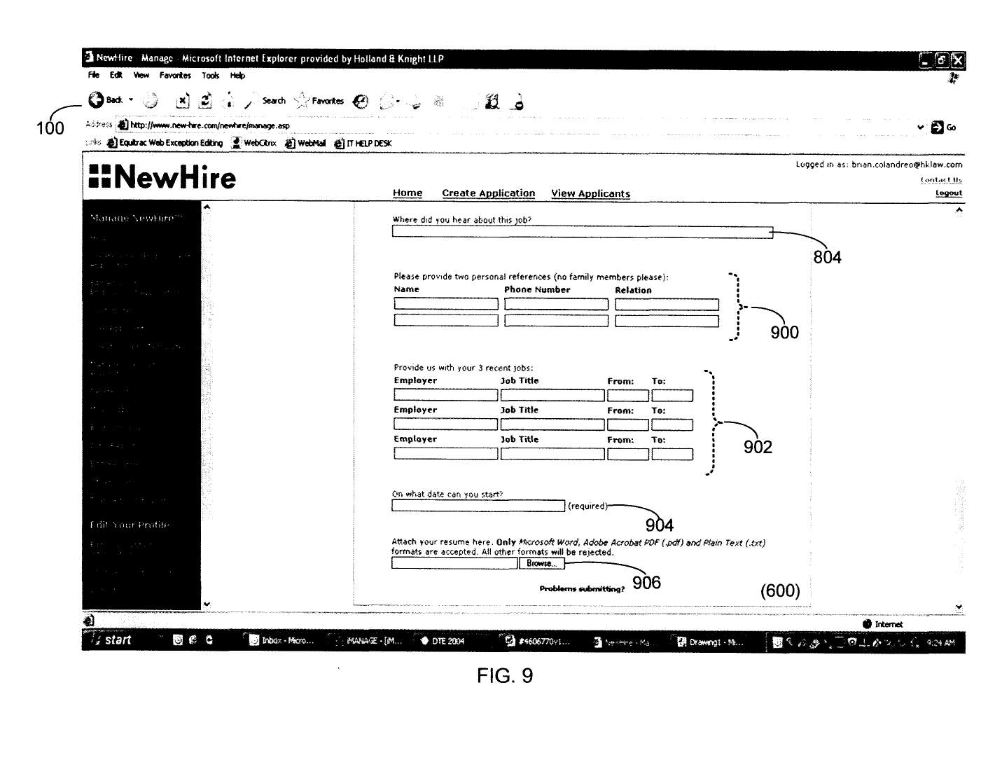

Referring also to FIGS. 6 through 9, as described above, starting from generic employment application 102 provided 202 by employment application and information management process 10, 10′, user 14 (i.e., an employer) may utilize employment application and information management process 10, 10′ and/or application 46 to generate 204 customized employment application 600 by entering any job-related information, selecting any desired pre-built generic questions and/or templates for pre-built job-specific questions for the specific job to be advertised and inputting any user-generated custom questions 504 into generic employment application 102.

Continuing with the above-stated example, based upon the options in the generic employment application 102 selected by user 14 (e.g., an employer), customized employment application 600 may include one or more questions related to at least one of applicant contact information 602, 700 an education history 702, 704, an employment history 706, 902, experience in one or more employment related areas 800, one or more skills 802, one or more personal references 900, one or more referrals 804, and applicant start date 904. Customized employment application 600 may also include a resume submission option 906. Additionally, as discussed above, customized employment application 600 may include user-generated custom questions 504 relevant to the advertised job.

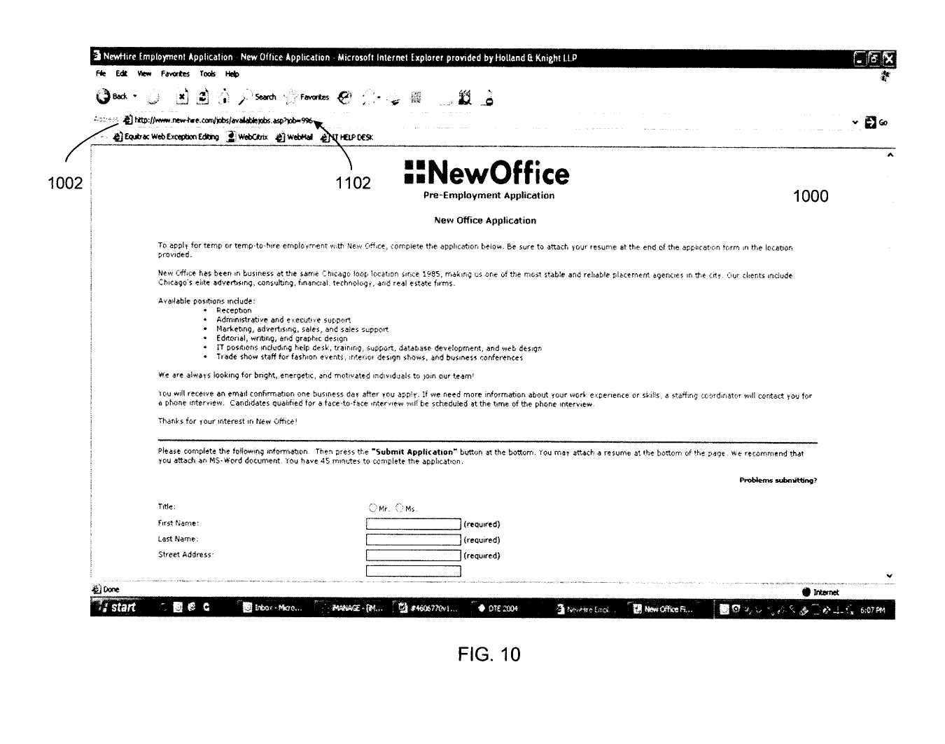

Customized employment application 600 may be unique to one specific job offered by one specific employer. Continuing with the above stated example, and referring also to FIG. 10, employment application and information management process 10, 10′ may associate 206 unique web page 1000 including customized employment application 600. Web address 1002 for unique web page 1000 may be provided when advertising the specific job in the newspaper, trade magazines and online. Rather than providing a generic application on a general job website, offering customized employment application 600 on unique web page 1000 may allow employers to ask job-specific questions, e.g., and thereby provide a more directed application process. In this manner, employers may receive prospective employee input specific to the advertised job through unique web page 1000, as well as track and compare applicants for the specific job more easily.

Employment application and information management process 10, 10′ may assign 208 unique job identification number 1102 to customized employment application 600. Unique job identification number 1102 may be used in advertising the specific job by including the unique job identification number 1102 in place of or in addition to the unique web page address 1002, especially where advertising space is limited. Providing a unique number for each customized employment application 600 generated by employers may help to reduce employer confusion over which job an applicant may be applying for, while providing easy access for prospective employees to the application for the specific job they are seeking.

Employment application and information management process 10, 10′ may associate 210 unique web page 1000 including customized employment application 600 with the unique job identification number 1102. The unique web page 1000 may be associated 210 with the unique job identification number 1102, e.g., by providing unique job identification number 1102 as a link to unique web page 1000 in an online job advertisement. For example, a prospective employee may access customized employment application 600 on unique web page 1000 when viewing an online job advertisement. The online job advertisement may include the unique job identification number 1102, which may be configured to link to unique web page 1000 when clicked or otherwise selected by the prospective employee. Unique job identification number 1102 may also be associated 210 with unique web page 1000, e.g., by providing access to unique web page 1000 through a second web page (e.g., associated with an employment website, such as the NEWHIRE website, provided by New Office Temps LTD at www.new-hire.com), where unique job identification number 1102 may be entered in a space provided, providing a link to unique web page 1000 including customized employment application 600. For example, a print or online job advertisement may include unique job identification number 1102 and a web address for an employment website. A prospective employee may access the employment website and enter the unique job identification number 1102 in a space provided and the unique web page 1000 including customized employment application 600 may be rendered.

Employment application and information management process 10, 10′ may allow one or more prospective employees (e.g., user 28) to access 212 the unique web page 1000 associated 206 with the customized employment application 600. For example, user 26, who may have found a job offering after searching online or in print, may access 212 unique web page 1000, e.g., via a web browser (not shown) residing on laptop computer 34, using unique web page address 1002 provided in the job offering. Additionally/alternatively, user 26 may access 212 unique web page 1000 using unique job identification number 1102 provided in the job offering, e.g., by clicking on job identification number 1102, if it is provided as a link, or entering it in a space provided on a job listing/searching website (e.g., the NEWHIRE website), either of which may provide access to the unique web page 1000 associated 206 with the customized employment application 600.

Employment application and information management process 10, 10′ may allow unique web page 1000, associated 206 with customized employment application 600, to be accessible to unregistered prospective employees. For example, rather than requiring user registration, such as obtaining a user name and password, before allowing users to view or fill out an employment application, any prospective employee may access 212 unique web page 1000 associated 206 with customized employment application 600, e.g., without prior registration on the NEWHIRE website.

Employment application and information management process 10, 10′ may receive 214 user input including prospective employee responses to one or more questions included within customized employment application 600. For example, user 26 (e.g., a prospective employee) may fill out customized employment application 600 (e.g., by completing at least a portion of the various information request fields of customized employment application 600), the information input by user 26 into the customized employment application 600 may be received 214 and uploaded from unique web page 1000.

Employment application and information management process 10, 10′ may store 216 the user input in customized employment application 600 in a data store (e.g., database 56, residing on storage device 24, coupled to server computer 20). For example, the user input may be stored on the server-side and it may be accessed remotely by the employer who generated 204 customized employment application 600 over a network (e.g., networks 16, 22). Additionally/alternatively, data storage may be implemented by a client-side application (not shown). For example, a data store may reside on client computer 12 accessed by user 14 (e.g., the employer who generated 204 customized employment application 600 using employment application and information management process 10, 10′). Similarly, the employer may access a server-side data store over network 16 and download and store 216 the user input locally on client computer 12.

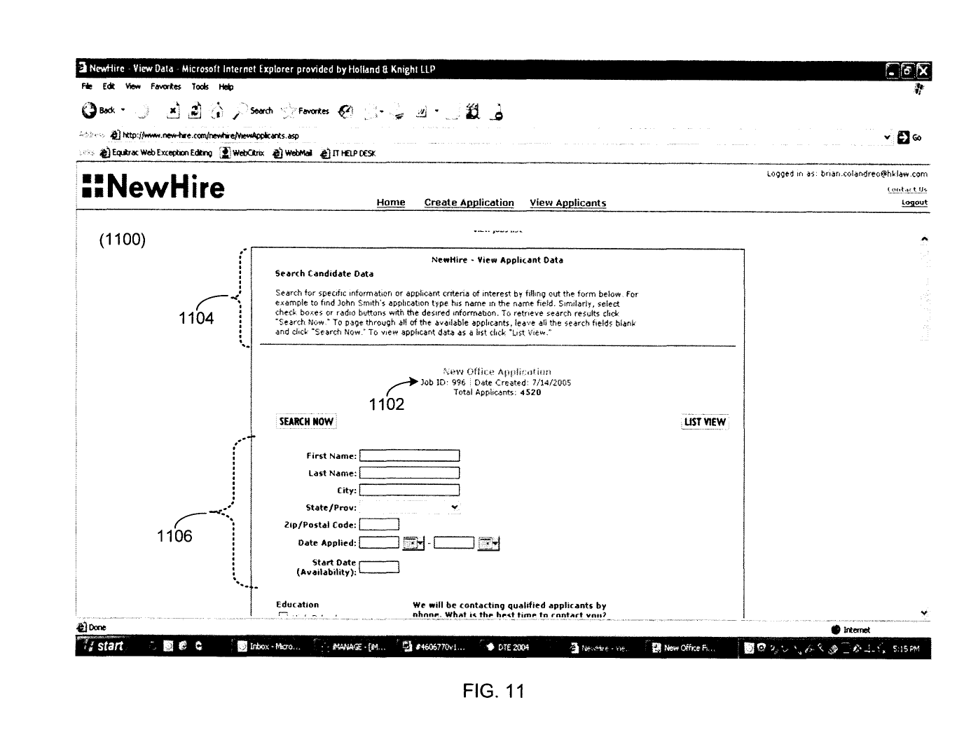

Continuing with the above-stated example, and referring also to FIG. 11, employment application and information management process 10, 10′ allow user 14, e.g., via user interface 1100, to conduct 218 searches 1104 of the user input data stored 216 in the data store. User interface 1100 may provide a search form, which may allow user 14 to select specific applicant response fields 1106. The various applicant response fields 1106 may be selected, e.g., based upon a particular point of interest to the employer. Further, the various applicant response fields 1106 may be linked to customized employment application 600. User 14 may search for and view all prospective employee user input data by leaving the search form 1100 blank. Additionally/alternatively, user 14 may select specific responses from the answer input fields 506 provided in customized employment application 600, e.g., which may be directed at an area of interest for determining if any of the prospective employees may be suitable for the position (e.g., based upon specific responses desired by user 14). User 14 may use this customized search 1104 function to find prospective employees, e.g., that may be of interest for an interview The customized search may also be used to elect applicants for further consideration and/or eliminate applicants from consideration who do not have the qualifications that the employer is seeking.

Employment application and information management process 10, 10′ may allow the employer to generate and append 220 comments related to the user input. Continuing with the above-stated example, and referring also to FIG. 1, user 14 may search (e.g., conduct 218 customized searches of user input data) and view one or more applications from one or more prospective employees. Employment application and information management process 10, 10′ may allow user 14 to include comments (e.g., in comments field 1200) related to one or more of the prospective applicants who have provided responses in customized employment application 600. Such comments may, for example, help user 14 keep track of which applicants he was interested in and for what specific reasons. For example, user 14 may generate 220 comments, e.g., in notes field 1202, regarding a specific applicant. Similarly, comments related to one or more applications may include information regarding the status of an application and/or applicant, e.g., in status information field 1204. Additionally/alternatively employment application and information management process 10, 10′ may allow user 14 to include information related to any contact with, or hiring status of, a perspective employee, e.g., in tracking information field 1206. Any generated 220 comments (e.g., which may be input in comments field 1200) may then be appended 220 to the specific (e.g., relevant) prospective employee's application. Such comments may be appended 220 by storing the comments as part of the stored 216 user input data (e.g., in database 56) or by storing the comments separately and associating or linking the comments to the user input.

Employment application and information management process 10, 10′ may provide unrestricted access to the user input data stored in the data store. Alternatively, employment application and information management process 10, 10′ may restrict 222 access to the user input data stored in the data store to the employer who generated customized employment application 600. Further, employment application and information management process 10, 10′ may restrict 220 access to the user input data stored in the data store to users designated by the employer. As such, employment application and information management process 10, 10′ may allow user 14 to maintain the user input data as confidential. For example, employment application and information management process 10, 10′ may restrict 222 access to the user input data to the employer and/or users designated by the employer via conventional security means, e.g., digital certificates, username/password restricted access (e.g., requiring a username and password for logging in 1208 to a secure website) Various other security features may be used for restricting 222 access to the user input data stored in data store.

Employment application and information management process 10, 10′ may provide 224 a plurality of access levels to the user input data stored 216 in the data store. As discussed above, an employer may wish to restrict access to the user input data for customized employment application 600. Additionally, the employer may choose to have different levels of access, e.g. for different users authorized to access the user input data. Different access levels may include, for example, the ability to view and print the user input data, the ability to generate and append 220 comments to the user input, etc. Employment application and information management process 10, 10′ may provide 224 the plurality of access levels, e.g., based upon, at least in part, different username/password combinations, digital certificates, and the like.

A number of implementations have been described. Nevertheless, it will be understood that various modifications may be made. Accordingly, other implementations are within the scope of the following claims.

What is claimed is:

1. A method comprising:
providing a generic employment application;
generating a customized employment application by an employer based upon, at least in part, the generic employment application;
associating a unique web page with the customized employment application; and
providing access by a prospective employee to the unique web page associated with the customized employment application.

2. The method of claim 1, wherein the customized employment application includes:
a job description;
one or more questions related to at least one of an education history, an employment history, experience in one or more employment related areas, one or more skills, one or more personal references and one or more referrals; and
a resume submission option.

3. The method of claim 1, wherein the customized employment application includes one or more custom questions generated by an employer.

4. The method of claim 1, wherein associating a unique web page with the customized employment application includes:
assigning a unique job identification number to the customized employment application; and
associating the unique web page including the customized employment application with the unique job identification number.

5. The method of claim 1, wherein the unique web page is accessible to unregistered prospective employees.

6. The method of claim 1, further including:
receiving user input including prospective employee responses to one or more questions included within the customized employment application; and
storing the user input in a data store.

7. The method of claim 6 further including conducting customized searches of the user input stored in the data store by the employer.

8. The method of claim 7, further including generating and appending comments related to the user input by the employer.

9. The method of claim 7, further including restricting access to the user input stored in the data store to the employer who generated the customized employment application.

10. The method of claim 7, further including providing a plurality of access levels to the user input stored in the data store.

11. A computer program product residing on a computer readable medium having a plurality of instructions stored thereon which, when executed by a processor, cause the processor to perform operations comprising:
providing a generic employment application;
generating a customized employment application by an employer based upon, at least in part, the generic employment application;
associating a unique web page with the customized employment application; and
providing access by a prospective employee to the unique web page associated with the customized employment application.

12. The computer program product of claim 11, wherein the customized employment application includes:
a job description;
one or more questions related to at least one of an education history, an employment history, experience in one or more employment related areas, one or more skills, one or more personal references and one or more referrals; and
a resume submission option.

13. The computer program product of claim 11, wherein the customized employment application includes one or more custom questions generated by an employer.

14. The computer program product of claim 11, wherein the instructions for associating a unique web page with the customized employment application include instructions for:
assigning a unique job identification number to the customized employment application; and
associating the unique web page including the customized employment application with the unique job identification number.

15. The computer program product of claim 11, wherein the unique web page is accessible to unregistered prospective employees.

16. The computer program product of claim 11, further including instructions for:
receiving user input including prospective employee responses to one or more questions included within the customized employment application; and
storing the user input in a data store.

17. The computer program product of claim 16 further including instructions for conducting customized searches of the user input stored in the data store by the employer.

18. The computer program product of claim 17, further including instructions for generating and appending comments related to the user input by the employer.

19. The computer program product of claim 17, further including instructions for restricting access to the user input stored in the data store to the employer who generated the customized employment application.

20. The computer program product of claim 17, further including instructions for providing a plurality of access levels to the user input stored in the data store.
